(19) United States
(12) Patent Application Publication
(10) Pub. No.: US 2010/0056717 A1
(43) Pub. Date: Mar. 4, 2010

(54) One Component Thermoset Latex Composition

(75) Inventors: Kevin Grant Suddaby, Morrisville, NC (US); Corey D. Crooks, Fuquay Varina, NC (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Mallard Creek Polymers, Charlotte, NC (US)

(21) Appl. No.: 12/262,584

(22) Filed: Oct. 31, 2008

Related U.S. Application Data
(60) Provisional application No. 61/001,591, filed on Nov. 2, 2007.

(51) Int. Cl. C08L 67/00; C08G 63/00

(52) U.S. Cl. 524/599; 528/271

(57) ABSTRACT

A shelf-stable, one-component, water-dispersed, film-forming, thermoset resin composition, which composition is also solvent free, formaldehyde-free, and latex compatible, is disclosed. The resin is a latex dispersion formed by emulsion polymerization of monomer mixtures including one or more carboxylic acid-containing monomers and hydroxyl-containing monomers, and ideally including monomers such as styrene, butadiene, and/or acetonitrile. Monomers such as (meth)acrylates or (meth)acrylamides may be substantially absent, to avoid off-gassing volatile organic compounds when the composition is cured. The compositions can be used, for example, to prepare reinforced glass mats, insulation, and roofing shingles, used in thermosetting paper applications, or can be dried, melted and shaped at a temperature below the cure temperature, and then cured at the cure temperature. The glass transition temperatures of the polymers in the compositions can be varied over a wide range by varying the monomer composition.

### FIELD OF THE INVENTION

This invention is generally in the area of thermosetting latex compositions, methods of using the compositions, and composite materials comprising the compositions.

### BACKGROUND OF THE INVENTION

Thermoset materials are used to form articles of manufacture such as composites, laminates, roofing shingles, and the like. Many thermoset resins, such as the urea/formaldehyde resins used to form shingles, produce formaldehyde when they are cured. Traditional formaldehyde-based resin systems also tend to slowly cure even when refrigerated, increasing in viscosity over time. Other thermoset are present in solution with volatile organic solvents, which are released into the atmosphere as the resins are cured. Additionally, many thermoset resins (such as epoxy resins) are present as two-part compositions, which must be combined in order for polymerization to take place.

It would be advantageous to have a shelf-stable, one component, thermoset resin free of volatile organic solvents, and which does not release formaldehyde upon curing. The present invention provides such a composition, as well as methods for using the composition, and articles of manufacture made from the composition.

### SUMMARY OF THE INVENTION

A one-component, water-dispersed, film-forming, thermoset resin composition is disclosed. The composition is shelf-stable, solvent free, formaldehyde-free, and latex compatible. Also disclosed are laminates comprising the thermoset resin, and methods of using the resin to produce such laminates.

The resin is a latex dispersion formed by emulsion polymerization of a blend of monomers, which blend specifically includes at least one carboxylic acid-containing monomer, such as (meth)acrylic acid, and at least one hydroxyl-containing monomer, such as hydroxyethyl acrylate. Ideally, monomers such as styrene, butadiene, and/or acetonitrile are present. Also, it is preferred that an esterification catalyst be bound to the polymer. This can be accomplished, for example, by including an appropriate monomer in the monomer mixture such that the resulting polymer includes a built-in esterification catalyst. Examples include styrenyl and vinyl sulfonic, sulfuric, phosphoric, phosphonic, and boronic acids.

In one embodiment, the monomer mixture used to prepare the resulting carboxylated polymer further includes C₄₋₈ conjugated diene monomers, such as butadiene. In another embodiment, the monomer mixture includes one or more of styrene, butadiene, nitrile, and (meth)acrylate monomers in addition to the carboxylic acid-containing and hydroxyl-containing monomers. The glass transition temperature of the latex can be controlled by judicious selection of the individual monomers, in particular, butadiene.

The thermosetting compositions can be used to prepare reinforced glass mats, carbon fiber mats, glass fibers, and carbon fibers impregnated with the compositions. The thermosetting compositions can also be used to prepare articles from mineral wool, natural and synthetic fibers, and wood particles. The mats and/or fibers can be molded to a desired shape, and cured by application of heat. In some embodiments, no volatile organics are release as the resin is cured—only water is released as the carboxylic acid and hydroxyl groups on the polymer backbone form ester linkages.

The fact that the thermoset resin is shelf-stable, and when cured, does not produce formaldehyde, and, ideally, other volatile organic compounds, is an advantage over traditional formaldehyde-based resin systems, which systems tend to slowly cure even when refrigerated, increasing in viscosity over time. Additional advantages include the fact that the compositions are solvent free, one component (as opposed to the multi-component binders systems typically used), water-dispersed (as opposed to aqueous solutions), latex-compatible (since they are formed from a stable latex themselves), film-forming thermoset resins that release water on curing (i.e., are formaldehyde free). The compositions can be cured upon application or at a later time (i.e. can be dried and processed as a thermoplastic and undergo curing in a separate stage). They can be used as a binder, or dried and processed as a thermoplastic and then cured.

Their glass transition temperatures can be varied over a wide range by varying the monomer composition, in one embodiment, by varying the amounts of styrene and butadiene that are present.

The compositions can be used to cure pre-pregs, which can be formed into desired articles of manufacture using appropriate molding and/or shaping processes, then cured by application of heat. The polymers can be crosslinked to form films and/or laminate or composite articles, without using materials which off-gas volatile organic compounds such as formaldehyde.

In one embodiment, the latex compositions are dried, and the polymers used in thermoplastic applications, then cured by application of additional heat.

### BRIEF DESCRIPTION OF THE FIGURES

FIG. 1 is a graph showing the glass transition temperatures (° C.) measured during heating cycles (° C.) during the curing of the polymers produced in Examples 1 and 2. The increase in glass transition temperatures with heating shows that the polymers are curing at the elevated temperatures.

### DETAILED DESCRIPTION

The processes, latex compositions, and articles of manufacture will be better understood with reference to the following detailed description.

### I. Monomers

The monomers used to prepare the latex typically include a carboxylic acid-containing monomer and a hydroxyl-containing monomer (i.e., to participate in crosslinking via ester formation), and an olefinic monomer, such as an unsaturated ester or amide. They can also include crosslinking monomers (i.e., those that include two or more double bonds).

The monomers can also include one or more of acrylamide, (meth)acrylates, acrylonitrile, conjugated diene monomers such as butadiene, and aromatic monomers such as styrene. In one embodiment, the latex composition is substantially devoid of formaldehyde-releasing materials, such as N-methylol(meth)acrylate and its derivatives, and also substantially devoid of other materials that might generate volatile organic compounds, such as monomers with ester or amide linkages, and their derivatives. By “substantially devoid” is meant less than about 1.5%, ideally less than about 1%, of the monomer mixture.

In particularly preferred embodiments where avoidance of monomers with ester or amide linkages is desirable, the compositions include, as substantially all of the monomeric components, styrene, butadiene, one or more carboxyl-containing monomers, one or more hydroxyl-containing monomers, and, optionally, a polymerizable esterification catalyst. Such compositions are described below in the representative Examples. In this context, “substantially all” is intended to mean at least about 80% by weight, and preferably at least 90% by weight, of the monomers used to form the latex compositions.

When styrene and butadiene are present in the monomer mixture, they can be in ratios of between about 1 to about 1, and about 1 to about 5, based on molar amounts of these monomers.

Acid Monomers

A number of unsaturated acid monomers may be used in the polymer latex composition. Exemplary monomers of this type include, but are not limited to, unsaturated mono- or dicarboxylic acid monomers such as acrylic acid, methacrylic acid, itaconic acid, fumaric acid, maleic acid, (or maleic anhydride, which hydrolyzes in water to form maleic acid), crotonic acid, β-carboxyethyl acrylate and the like. Derivatives, blends, and mixtures of the above may be used. Methacrylic acid is preferably used. Partial esters and amides of unsaturated polycarboxylic acids in which at least one carboxylic group has been esterified or aminated can also be used.

Hydroxyl-Containing Monomers

Any ethylenically unsaturated monomer that includes or can generate a free hydroxyl group can be used to form the compositions described herein. Representative hydroxyl containing monomers include hydroxyl-containing vinyl monomers, such as monoesters of polyols having 2 to 6 carbon atoms with α,β-monoethylenically unsaturated monocarboxylic acids, such as 2-hydroxyethyl acrylate and methacrylate, 2-hydroxypropyl acrylate and methacrylate, 3-hydroxypropyl acrylate and methacrylate, 2-hydroxybutyl acrylate and methacrylate, 3-chloro-2-hydroxybutyl acrylate and methacrylate, diethylene glycol monoacrylate and monomethacrylate, and dipropylene glycol monoacrylate and monomethacrylate. Other examples include the monoacrylate and monomethacrylates of polyether glycols such as polyethylene glycol and polypropylene glycol, glycerine mono- and di-acrylates and methacrylates.

### Polymerizable and Non-Polymerizable Esterification Catalysts

A “built-in” curing catalyst can be provided by co-polymerizing a monomer with pendant acidic groups which are strongly acidic enough to catalyze the crosslinking, via esterification, of the carboxylic acid and hydroxyl groups. Representative monomers include 2-methyl-2-[(1-oxo-2-propenyl)amino]-1-propanesulfonic acid, styrene sulfonic acid, vinyl sulfonic acid, styrene boric acid, vinyl boric acid, styrene sulfuric acid, vinyl sulfuric acid, styrene phosphoric acid, vinyl phosphoric acid, styrene phosphonic acid, and vinyl phosphonic acid.

If the composition does not include a built-in curing catalyst, it can include another catalyst suitable for crosslinking the carboxylic acid and hydroxyl groups. For example, phosphorous-containing catalysts include alkali metal polyphosphates, alkali metal dihydrogen phosphates, polyphosphoric acids, alkyl phosphinic acids, or oligomers or polymers bearing phosphorous-containing groups, for example, addition polymers of acrylic and/or maleic acids formed in the presence of sodium hypophosphite, addition polymers prepared from ethylenically unsaturated monomers in the presence of phosphorous salt chain transfer agents or terminators, and addition polymers containing acid-functional monomer residues such as, for example, copolymerized phosphoethyl methacrylate, and like phosphonic acid esters. Also, the composition can include copolymerized vinyl sulfonic acid monomers, and their salts.

The catalyst level, if not polymerized into the carboxylic/hydroxyl-containing polymers, is between about 0.1% and about 40%, by weight, based on the weight of the polymer. In one embodiment, the level is between about 0.5% and about 10%, by weight of the polymer. Where the catalyst is initially in the form of a polymerizable monomer, and is polymerized into the growing polymer chain, it is typically present in an amount between 0.1 and 10 by weight of the polymer.

Unsaturated Ester and Amide Monomers

The monomers can also include unsaturated ester or amide monomers, although these may not be preferred in certain embodiments, particularly where it is desired to avoid off-gassing of volatile organic compounds during thermal curing of the thermoset resin. In such embodiments, these monomers are substantially absent, i.e., present in less than about 20% of the monomer mixture, and, ideally, less than about 10% of the monomer mixture.

These types of monomers are well known, and include, for example, acrylates, methacrylates, acrylamides and methacrylamides and derivatives thereof. The acrylic and methacrylic acid derivatives may include functional groups such as amino groups, hydroxy groups, epoxy groups and the like. Exemplary acrylates and methacrylates include, but are not limited to, various (meth)acrylate derivatives including, methyl methacrylate, ethyl methacrylate, butyl methacrylate, glycidyl methacrylate, 2-ethylhexl(meth)acrylate, dimethylaminoethyl(meth)acrylate and their salts, diethylaminoethyl(meth)acrylate and their salts, acetoacetoxyethyl(meth)acrylate, 2-sulfoethyl(meth)acrylate and their salts, methoxy polyethylene glycol mono(meth)acrylate, polypropylene glycol mono(meth)acrylate, tertiary butyl aminoethyl (meth)acrylate and their salts, benzyl(meth)acrylate, 2-phenoxyethyl(meth)acrylate, gamma-methacryloxypropyltrimethoxysilane, propyl(meth)acrylate, isopropyl(meth)acrylate, isobutyl (meth)acrylate, tertiary butyl (meth)acrylate, isobornyl (meth)acrylate, isodecyl(meth)acrylate, cyclohexyl(meth)acrylate, lauryl(meth)acrylate, methoxyethyl (meth)acrylate, hexyl (meth)acrylate, stearyl(meth)acrylate, tetrahydrofufuryl(meth)acrylate, 2(2-ethoxyethoxy), ethyl(meth)acrylate, tridecyl(meth)acrylate, caprolactone(meth)acrylate, ethoxylated nonylphenol(meth)acrylate, propoxylated allyl(meth)acrylate and the like. Other acrylates include methyl acrylate, ethyl acrylate, butyl acrylate, and glycidyl acrylate.

Exemplary (meth)acrylamide derivatives include, but are not limited to, acrylamide, N-methyolacrylamide, N-methyolmethacrylamide, 2-acrylamido-2-methylpropanesesulfonic acid, methacrylamide, N-isopropylacrylamide, tert-butylacrylamide, N—N′-methylene-bis-acrylamide, N,N-dimethylacrylamide, methyl(acrylamido) glycolate, N-(2,2 dimethoxy-1-hydroxyethyl) acrylamide, acrylamidoglycolic acid, alkylated N-methylolacrylamides such as N-methoxymethylacrylamide and N-butoxymethylacrylamide.

Suitable dicarboxylic ester monomers may also be used such as, for example, alkyl and dialkyl fumarates, itaconates and maleates, with the alkyl group having one to eight carbons, with or without functional groups. Specific monomers include diethyl and dimethyl fumarates, itaconates and maleates. Other suitable ester monomers include di(ethylene glycol) maleate, di(ethylene glycol) itaconate, bis(2-hydroxyethyl) maleate, 2-hydroxyethyl methyl fumarate, and the like. The mono and dicarboxylic acid ester and amide monomers may be blended or copolymerized with each other.

Ester and amide monomers which may be used in the polymer latex composition also include, for example, partial esters and amides of unsaturated polycarboxylic acid monomers. These monomers typically include unsaturated di- or higher acid monomers in which at least one of the carboxylic groups is esterified or aminated. One example of this class of monomers is of the formula RxOC—CH═CH—COOH wherein R is a C₁₋₁₈ aliphatic, alicyclic or aromatic group, and X is an oxygen atom or a NR′ group where R′ represents a hydrogen atom or R group. Examples include, but are not limited to, monomethyl maleate, monobutyl maleate and monooctyl maleate. Partial esters or amides of itaconic acid having C₁₋₁₈ aliphatic, alicyclic or aromatic groups such as monomethyl itaconate can also be used. Other mono esters, such as those in which R in the above formula is an oxyalkylene chain can also be used. Blends or copolymers of the partial esters and amides of the unsaturated polycarboxylic acid monomer can also be used.

Conjugated Diene Monomers

Conjugated diene monomers can also be used. Representative conjugated diene monomers include, but are not limited to, C₄₋₉ dienes. Examples of these include butadiene monomers such as 1,3-butadiene, 2-methyl-1,3-butadiene, and the like. Blends or copolymers of the diene monomers can also be used. A particularly preferred conjugated diene is 1,3-butadiene.

The addition of these monomers, and their relative amounts, can be used to control the glass transition temperature of the resulting polymers, in some embodiments making them relatively tacky or giving soft products after curing.

Aromatic Monomers

For the purposes of the invention, the term “aromatic monomer” is to be broadly interpreted and include, for example, aryl and heterocyclic monomers. Exemplary aromatic vinyl monomers which may be employed in the polymer latex composition include styrene and styrene derivatives such as alpha-methyl styrene, p-methyl styrene, vinyl toluene, ethylstyrene, tert-butyl styrene, monochlorostyrene, dichlorostyrene, vinyl benzyl chloride, vinyl pyridine, vinyl naphthalene, fluorostyrene, alkoxystyrenes (e.g., p-methoxystyrene), and the like, along with blends and mixtures thereof.

Crosslinking Monomers

The monomers used to prepare the polymers can include crosslinking monomers, the selection of which is apparent to one skilled in the art. Representative crosslinking monomers include vinylic compounds (e.g., divinyl benzene); allyllic compounds (e.g., allyl methacrylate, diallyl maleate); and multifunctional acrylates (e.g., di, tri and tetra (meth)acrylates).

Polymerization of the Monomers

The composition is formed by polymerizing a monomer mixture including one or more carboxylic acid-containing monomers, or their salts, and one or more hydroxyl containing monomers, along with non-hydroxyl and non-carboxyl containing monomers, of the types and in the relative amounts described above.

The monomers are preferably polymerized by emulsion polymerization. This method often involves the addition of conventional surfactants and emulsifying agents during the polymerization reaction, although polymerizable surfactants that can be incorporated into the latex also can be used.

For example, anionic surfactants can be selected from the broad class of sulfonates, sulfates, ethersulfates, sulfosuccinates, and the like, the selection of which will be readily apparent to anyone skilled in the art. Nonionic surfactants may also be used to improve film and glove characteristics, and may be selected from the family of alkylphenoxypoly(ethyleneoxy)ethanols where the alkyl group typically varies from C₇₋₁₈ and the ethylene oxide units vary from 4-100 moles. Various preferred surfactants in this class include the ethoxylated octyl and nonyl phenols. Ethoxylated alcohols are also desirable surfactants. A typical anionic surfactant is selected from the diphenyloxide disulfonate family, such as benzenesulfonic acid, dodecyloxydi-, disodium salt. In addition to, or in place of the surfactants, a polymeric stabilizer may be used in the composition of the invention.

The polymer can include crosslinking agents and other additives, the selection of which will be readily apparent to one skilled in the art.

Peroxides, chelating agents (e.g., ethylendiaminetetraacetic acid), dispersants (e.g., salts of condensed naphthalenesulfonic acid); buffering agents (e.g., ammonium hydroxide); and polymerization inhibitors (e.g., hydroquinone), can also be used. Chain transfer agents (e.g., alkyl mercaptans, carbon tetrachloride and bromotrichloromethane) can also be used, preferably less than about 5 percent based on the weight of the monomers. More preferably, the chain transfer agent is used from about 0.0 to about 3 weight percent, and most preferably from about 0.1 to about 3 weight percent.

The monomers used in forming the polymer latex composition of the invention may be polymerized in a manner known to those who are skilled in the art. For example, the monomers may be polymerized at a temperature preferably between about 5-95° C., and more preferably between about 10 and 70° C.

In another embodiment, solution polymerization is used, wherein a solvent is used as a polymerization medium. The solvent is selected so that the monomers are all soluble in the resulting solution during polymerization. Solution polymerization and emulsion polymerization are well known to those of skill in the art.

II. Articles of Manufacture Prepared from the Compositions

The compositions can be used to prepare a variety of articles of manufacture. Examples include pre-pregs, composite and laminate materials, fiberglass insulation products, reinforced webs, roofing shingles, thermosetting paper, and the like.

Heat-resistant non-wovens prepared using the thermosetting compositions described herein can be used for applications such as insulation balts or rolls, as reinforcing mat for roofing or flooring applications, as roving, as microglass-based substrate for printed circuit boards or battery separators, as filter stock, as tape stock, as tape board, in duct liners or duct board, and as reinforcement scrim in cementitious and non-cementitious coatings for masonry. The pre-pregs can be used to form composite materials.

Production of Fiberglass Products

Fiberglass products can be prepared using conventional techniques. As is well known, a porous mat of fibrous glass can be produced by fiberizing molten glass and immediately forming a fibrous glass mat on a moving conveyor. The formaldehyde-free curable compositions described herein are applied during this process. The expanded mat is then conveyed to and through a curing oven wherein heated air is passed through the mat to dry and cure the resin. The mat is slightly compressed to give the finished product a predetermined thickness and surface finish. Typically, the curing oven is operated at a temperature from about 150 to about 325° C. Preferably, the temperature ranges from about 180 to about 225° C. Generally, the mat resides within the oven for a period of time from about ½ minute to about 3 minutes. For the manufacture of conventional thermal or acoustical insulation products, the time ranges from about ¾ minute to about 11/2 minutes. The fibrous glass having a crosslinked binder matrix emerges from the oven in the form of a batt which may be compressed for packaging and shipping and which will thereafter substantially recover its vertical dimension when unconstrained.

The formaldehyde-free curable compositions described herein can also be applied to an already-formed non-woven by conventional techniques, for example, air or airless spraying, padding, saturating, roll coating, curtain coating, beater deposition, coagulation, or the like.

The compositions, after being applied to a non-woven, are heated to effect drying and curing. The duration and temperature of heating will affect the rate of drying, processability and handleability, and property development of the treated substrate. Heat treatment at about 120° C., to about 400° C., for a period of time between about 3 seconds to about 15 minutes can be carried out; with treatment at about 150° C. to about 250° C. being preferred. The drying and curing functions may be effected in two or more distinct steps, if desired. For example, the composition can be first heated at a temperature and for a time sufficient to substantially dry but not to substantially cure the composition and then heated for a second time at a higher temperature and/or for a longer period of time to effect curing. Such a procedure, referred to as “B-staging”, can be used to provide binder-treated non-wovens, for example, in roll form, which can be cured at a later stage, with or without forming or molding into a particular configuration, concurrent with the curing process.

When used to produce fiberglass insulation products, the composition can be used to bond together matted glass fibers. This can be accomplished by drawing molten streams of glass into fibers of random lengths, and blowing these fibers into a forming chamber where they are randomly deposited as a mat onto a traveling conveyor. The compositions can be sprayed onto the fibers while they are in transit and still hot. The coated fibrous mat can then be transferred to a curing oven to cure the composition and rigidly bond the glass fibers together. In this embodiment, the composition can replace all or part of the phenol-formaldehyde binders traditionally used in this industry, reducing or eliminating the formation of formaldehyde off-gassing.

Formation of Roofing Shingles

Asphalt roofing shingles are commonly made from wet-laid glass fiber mats topped with randomly disposed chopped glass fibers, topped with asphalt. The glass fiber mats have replaced felt mats, and the chopped glass fibers have replaced cellulose fibers. The mats can be impregnated or coated with asphalt.

Typically, the chopped glass fibers are randomly disposed on a fiber mat, and bonded together using a binder. The binder adhesively secures crossed glass fibers together, contributing to good handling of the mats during processing into fiberglass shingles, as well as providing the necessary physical performance properties such as strength, flexibility and long life that is required during roof installation and during the service life of the roof. Fiberglass shingles resist curl and blister wells and will not rot and because of the nonflammable nature of the fiberglass mats, they are given a Class A fire rating.

In one embodiment, the fiberglass mats are coated with asphalt, rather than being impregnated with asphalt. This reduces the rigidity of the shingle, so the binder used to prepare the fiberglass mat has to also provide suitable mat strength for handling without loss of flexibility. The thermosetting compositions described herein, when applied in suitable concentrations, can be used alone, or in blends with urea-formaldehyde resins in two-component systems, to produce roofing shingles with desirable properties such as mat strength.

Processes for forming such shingles are well known to those of skill in the art, and are described, for example, in U.S. Pat. No. 4,571,356, the contents of which are hereby incorporated by reference.

Thermosetting Paper Applications

The compositions described herein can also be used as binders for paper or wood products, where the adhesive properties are tailored to the chemical nature of the cellulosic substrates. In some embodiments, the compositions are used as a binder for paper while it is manufactured, and the paper is then used in various thermosetting applications.

One relatively large application of this type is decorative plastic laminates. These materials are durable flat sheeting material used in home and industrial furnishings, often under the brand name Formica®. These laminates are commonly used to surface kitchen counters, table tops, and cabinetry because of their resistance to stains, scratches, and heat.

These laminates include three layers main layers, the first of which is a bottom layer of brown paper coated with phenolic resin, the second of which is a layer of paper decorated with a desired pattern, and the third of which is a clear sheet layer. Typically, both the second and third layers are coated with melamine resin. However, since both the phenolic and melamine resins tend to off-gas formaldehyde when cured, the compositions described herein can replace all or a portion of these resins and provide a laminate sheet with similar performance.

The process for forming these laminates includes three main steps. First, strips/sheets of paper are soaked in resin. Since the laminates can be made in different grades or thicknesses, depending on their intended uses, there may be from 7-18 layers of paper combined into the final sheet, with the bottom layers made of kraft paper. The paper comes in ribbons of different widths, typically three, four, or five feet wide. The kraft paper is run through a “bath tub” or vat containing the thermosetting latex composition described herein.

The paper for the top layer of the sheet is translucent, and is run through a vat of the thermosetting latex composition described herein. A decorative layer is typically provided just beneath the top layer, and this layer is a sheet of paper printed with the color or design that will show through the clear top layer for the desired surface pattern. This sheet is also run through a vat of the thermosetting latex composition described herein. The resin-impregnated sheets are then put into a drying chamber, then cut and stacked in layers with the clear layer and optional decorative layer on top of the kraft paper.

The paper layers are then loaded onto a flat-bed hydraulic press for final curing. The press compresses the sandwich of resin-soaked paper, while heating it to a high temperature. The heat cures the thermosetting latex composition described herein. The final product is a rigid laminated sheet, which retains its shape, even at high temperatures. The sheet is then cut into the desired size and shape, and is typically bonded to a building material such as plywood, flakeboard, fiberboard, or metal.

Use of the Compositions to Produce Laminates and Composites

When used in pre-preg and other such applications, fibers, such as glass or carbon fibers, are impregnated with the resin, molded into a desired shape, and cured by application of heat. Pre-preg applications are commonly used to prepare molded articles, in aerospace and high-end automotive applications, to produce exercise equipment such as golf clubs, and the like.

In these applications, the fibers are preferably unidirectional, i.e., predominantly extend in a common direction. Thus, the fibers can include multiple side-by-side tows, i.e., loose bundles of fibers. The tows and the fibers may all extend in the common direction, or there may be some transverse fibers. In the latter case, the transverse fibers are preferably such as to exert little or no positional or dimensional control on the unidirectional fibers. The compositions can also be used to impregnate woven or non-woven materials. The resins can be impregnated into the fibers using known techniques, including wicking techniques.

The fibers can be synthetic and natural fibers, glass, ceramic, metal and carbon fibers. Materials which may have very small filament diameters, such as carbon fibers are especially suitable. The fibers may be continuous or may have discontinuities and they, for example, may be stretch-broken or otherwise selectively discontinuous.

The laminate materials formed from the impregnated fibers and/or woven or non-woven materials are typically built up in layers, such as a first layer and a further layer or layers. The first layer is preferably a solid, substantially continuous film (i.e., substantially without spaces or openings therein) which may tacky, but sufficiently coherent and solid to be self-supporting at normal temperatures. This layer can be entirely resin, or a blend of resin and reinforcing materials, such as a pre-preg layer.

There should be sufficient amounts of the composition in the first layer to impregnate all or part of the further layer during processing of the material, e.g., when subjected to heat and pressure.

The further layer or layers are ideally formed from the same composition, and is similarly preferably sufficiently solid and coherent to be self-supporting at normal temperatures. In this manner, the further layer or layers can blend smoothly with the first layer, without adversely affecting the integrity of the cured component. The further layer or layers can be applied in any suitable manner, including transfer, e.g., via a transfer film, or by direct application to the surface. Suitable application techniques include gravure printing, reverse roll coating, forward roll coating, scatter coating, spraying, powder coating, resin gun or cartridge deposition, etc.

The layers can be linked or continuous solid parts, and can also include wholly separate or discontinuous solid parts, and the material formed when the composition is cured can have any desirable shape. It is also possible to establish the further layer by pull-through of resin material from the first layer. This may be done by an ultrasonic technique. This pull through may result in discrete solid parts, i.e., such that the further layer is separate from the first layer, or linked solid parts, i.e., with linking strands extending between the further and first layer through the fibrous material.

The amounts and relative proportions of the resin in the first and further layers will be selected in accordance with the desired use of the cured materials, using techniques known to those of skill in the art. For example, the amount of the composition in the first layer may be between about 30 and 50% by weight of this layer, whereas the amount of the composition in subsequent layers may be significantly less, for example, between about 0.1 and 20%, of such further layer(s).

When carbon fiber or other low density materials are used as the reinforcing fibers, the resulting composite materials have relatively low densities.

The present invention will be better understood with reference to the following non-limiting examples. Examples 1-5 relate to the preparation of representative thermosetting latex compositions, Examples 6-8 relate to the properties of the resulting compositions, and Examples 9-13 relate to the evaluation of a representative latex as a binder for fiberglass mats.

### Examples 1-5

### Preparation of Representative Thermosetting Latex Compositions

### Example 1

2764 g deionized water, 0.9066 g of the trisodium salt of ethylenediaminetetraacetic acid, and 22.7 g of a seed latex was charged to an agitated reactor and heated to 185° F. 634.6 g styrene, 360.8 g methacrylic acid, 272 g butadiene, 545.8 g hydroxyethyl methacrylate, and 1.81 g of tertiary dodecylmercaptan, were fed into the reactor over 240 minutes. 362.6 g deionized water, 12.7 g of the sodium salt of linear dodecylbenzensulfonic acid, and 7.25 g of sodium persulfate were fed to the reactor over 270 minutes starting at the same time as the other fed components. The temperature was maintained at 185° F. throughout the reaction. At 270 minutes the reactor contents were cooled to room temperature. The reactor and resultant latex were clean containing only traces of coagulum.

The minimum film forming temperature of the latex was measured and found to be 76° C.

### Example 2

2597 g deionized water, 0.9066 g of the trisodium salt of ethylenediaminetetraacetic acid, and 22.7 g of a seed latex was charged to an agitated reactor and heated to 185° F. 181.3 g deionized water, 607.4 g styrene, 360.8 g methacrylic acid, 272 g butadiene, 545.8 g hydroxyethyl methacrylate, 1.81 g of tertiary dodecylmercaptan, and 27.2 g 2-methyl-2-[(1-oxo-2-propenyl)amino]-1-propanesulfonic acid were fed into the reactor over 240 minutes. 362.6 g deionized water, 12.7 g of the sodium salt of linear dodecylbenzensulfonic acid, and 7.25 g of sodium persulfate were fed to the reactor over 270 minutes starting at the same time as the other fed components. The temperature was maintained at 185° F. throughout the reaction. At 270 minutes the reactor contents were cooled to room temperature. Small amounts of coagulum were found on the reactor walls (approximately 1.7% of the material charged) and in the resultant latex (approximately 1.4% of the material charged).

The minimum film forming temperature of the latex was measured and found to be 82° C.

### Example 3

2600 g deionized water, 0.905 g of the trisodium salt of ethylenediaminetetraacetic acid, and 11.31 g of a seed latex was charged to an agitated reactor and heated to 185° F. 181 g deionized water, 271.5 g styrene, 360.2 g methacrylic acid, 606.4 g butadiene, 544.8 g hydroxyethyl methacrylate, 1.81 g of tertiary dodecylmercaptan, and 27.2 g 2-methyl-2-[(1-oxo-2-propenyl)amino]-1-propanesulfonic acid were fed into the reactor over 210 minutes. 331 g deionized water, 25.3 g of benzenesulfonicacid, dodecyloxydi-, disodium salt, and 7.24 g of sodium persulfate were fed to the reactor over 240 minutes starting at the same time as the other fed components. The temperature was maintained at 185° F. throughout the reaction. At 270 minutes the reactor contents were cooled to room temperature. There was mild plating on the reactor system and the resultant latex contained approximately 0.14% of the material charged as coagulum.

### Example 4

2613 g deionized water, 0.8835 g of the trisodium salt of ethylenediaminetetraacetic acid, and 11.04 g of a seed latex was charged to an agitated reactor and heated to 185° F. 176.7 g deionized water, 265 g styrene, 351.6 g methacrylic acid, 591.9 g butadiene, 531.9 g hydroxyethyl methacrylate, 45.94 g of tertiary dodecylmercaptan, and 26.5 g 2-methyl-2-[(1-oxo-2-propenyl)amino]-1-propanesulfonic acid were fed into the reactor over 210 minutes. 353.4 g deionized water, 24.7 g of benzenesulfonic acid, dodecyloxydi-, disodium salt, and 7.07 g of sodium persulfate were fed to the reactor over 240 minutes starting at the same time as the other fed components. The temperature was maintained at 185° F. throughout the reaction. At 285 minutes the reactor contents were cooled to room temperature. The reactor and latex were clean and contained negligible amounts of coagulum.

### Example 5

2601 g deionized water, 0.8905 g of the trisodium salt of ethylenediaminetetraacetic acid, and 11.13 g of a seed latex was charged to an agitated reactor and heated to 185° F. 178.1 g deionized water, 267.1 g styrene, 354.3 g methacrylic acid, 596.5 g butadiene, 536 g hydroxyethyl methacrylate, 32.1 g of tertiary dodecylmercaptan, and 26.7 g 2-methyl-2-[(1-oxo-2-propenyl)amino]-1-propanesulfonic acid were fed into the reactor over 210 minutes. 356.2 g deionized water, 24.9 g of benzenesulfonic acid, dodecyloxydi-, disodium salt, and 7.12 g of sodium persulfate were fed to the reactor over 240 minutes starting at the same time as the other fed components. The temperature was maintained at 185° F. throughout the reaction. At 255 minutes the reactor contents were cooled to room temperature. The reactor was clean and the resultant latex contained approximately 0.04% of the material charged as coagulum.

### Example 6

### Evaluation of the Effect of Thermal Curing on Glass Transition Temperature

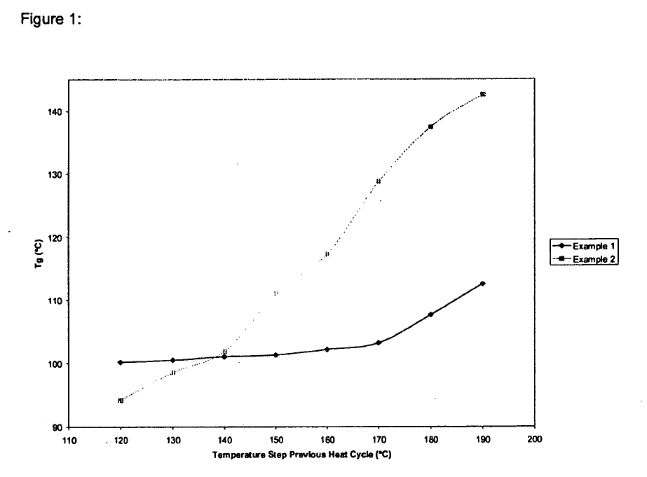

Samples of the latex from Examples 1 and 2 were dried and subjected to sequential temperature sweeps using modulated differential scanning calorimetry (MDSC). The experiment consisted of heating the sample to 120° C. and keeping it isothermal for 5 minutes. The sample was then subjected to a cooling cycle. Each cooling cycle consisted of cooling the sample at 20.00° C./min to the same temperature, 70° C. in the case of the Example 1 sample and 50° C. in the case of Example 2 sample and holding the sample isothermal for 5 minutes. The sample was then subjected to alternating heating and cooling cycles where a heating cycle consists of ramping the temperature at 3.00° C./min to the cycle temperature and them immediately starting the next cycle. The first heating cycle took the sample to 130° C. and the temperature was increased by 10° C. in each subsequent heating cycle until 190° C. The 190° C. heating cycle is repeated. Temperature modulation of +/−1.00° C. every 60 seconds was initiated when the sample reached the ending temperature during the first cooling cycle. The glass transition temperatures measured during each heating cycle are shown in FIG. 1. The increase in glass transition temperature with heating shows curing.

### Example 7

### Evaluation of Latex Compositions Before and After Thermal Curing

The glass transition temperatures of the dried latexes from Examples 1-5 are given in Table 1 both before and after curing. The difference in glass transition temperature between the cured and uncured materials shows curing is occurring.

For Examples 1 and 2 the uncured glass transition temperature are the first glass transition temperature measured and the cured glass transition temperature is the last glass transition temperature measured by MDSC as described in Example 6.

MDSC analysis was also conducted on the material from Example 3. The sample was equilibrated at 20.00° C. and temperature modulation of +/−1.00° C. every 60 seconds was initiated. The sample was held isothermal for 5 minutes. All temperature ramps were at 3.00° C./min. The temperature was then ramped to 120° C. then immediately cooled to 0° C. and allowed to equilibrate. The sample was then ramped up to 190° C. The glass transition determined during this heating cycle was taken as the uncured glass transition temperature. The sample was kept at 190° C. for 15 minutes and then cooled to 0° C. and allowed to equilibrate. The temperature was then ramped to 190° C. and the glass transition temperature during this ramp was taken as the cured glass transition temperature.

Conventional differential scanning calorimetry (DSC) was used to analyze the material from Examples 4 and 5. The procedure used to determine the uncured glass transition temperatures was to ramp the temperature of the samples from ambient to 100° C. then cool the samples at −70° C. and then ramp the temperature back up to 100° C. All ramps were at 10.00° C./min. The uncured glass transition temperature was determined from data from the last heat up stage. For the cured glass transition temperature the samples were heated from ambient temperature to 250° C., then cooled to −100° C. and then ramped to 250° C. The cured glass transition temperature was determined from the data generated during the last heat up stage. All heating ramps were at 10.00° C./min and the cooling ramp was at 5.00° C./min during the determination of the cured glass transition temperatures.

TABLE 1

| | Tg (° C.) | Tg (° C.) | |
|---|---|---|---|
| Material | uncured | cured | ΔTg |
| Example 1 | 100 | 113 | 13 |
| Example 2 | 94 | 140 | 46 |
| Example 3 | 52 | 92 | 40 |
| Example 4 | 29 | 59 | 30 |
| Example 5 | 37 | 76 | 39 |

### Example 8

### Melt Processing of a Representative Latex Formulation

The latex from Example 4 was dried in a vacuum oven set at approximately 70° C. The dried resin was then placed in a grinder to making fine granules of the resin. The granules were then melt-processed. This was done by pouring them onto a silicone rubber sheet in a cold vacuum oven and placing another silicone rubber sheet on top with spacers in between and placing a weighted metal plate on top of the upper silicone sheet. The oven was evacuated and then heated to approximately 75° C. The weighted metal plate caused the granules to flow. Once this had occurred the oven was turned off and vacuum released. When the oven had cooled, the silicone was removed. The granules had flowed together, giving a clear plastic disc.

### Examples 9-13

### Evaluation of a Representative Latex as a Binder for Fiberglass Mats

### Example 9

The latex from Example 4 was neutralized to a pH of approximately 7 with 14% ammonium hydroxide. 1.25 inch fiber glass mats were prepared at 1.8 lb/square and 20% loss on ignition by applying the neutralized latex as a binder and drying for 3 minutes at 300° F.

### Example 10

A glass mat from Example 9 was placed on 2 supports approximately 4 inches apart and a 20 g weight placed on the glass mat. At room temperature the glass mat was able to support the weight. When place in 140° C. oven the glass mat became unable to support the weight almost immediately. After curing in an oven at 190° C. for approximately 10 minutes the glass mat was able to support the weight at both room temperature and in the 140° C. oven.

### Example 11

A glass mat from Example 9 was placed in a stacking bread pan and a matching bread pan inserted into the first bread pan to impart a draw to the glass mat. This was placed in a 140° C. oven for approximately 1 minute to thermally mold the mat. The bread pans were then removed from the oven and the glass mat removed. The glass mat retained the draw of the bread pans. The glass mat was then placed in the 140° C. oven and quickly recovered its original flat shape.

### Example 12

A glass mat from Example 9 was placed in a stacking bread pan and a matching bread pan inserted into the first bread pan to impart a draw to the glass mat matching that of the bread pans. This was placed in a 190° C. oven for approximately 10 minute to thermally mold and cure the mat. The bread pans were then cooled and removed from the oven and the glass mat removed. The glass mat retained the draw of the bread pans. The glass mat was then placed in the 140° C. oven and retained the draw of the bread pans even after 15 minutes.

The examples show that the technology described herein can be used to provide thermosetting compositions suitable for use in various thermosetting applications, where the compositions provide the finished articles of manufacture with desirable physical and chemical properties for their intended use. When used to reinforce glass mats, such as those used to prepare shingles, the data show that the mats were provided with adequate strength, even when heated (indicating adequate crosslinking had occurred to produce a crosslinked thermoset material).

Those skilled in the art will recognize that the present invention is capable of many modifications and variations without departing from the scope thereof. Accordingly, the detailed description and examples set forth above are meant to be illustrative only and are not intended to limit, in any manner, the scope of the invention as set forth in the appended claims.

I claim:

1. A thermosetting resin formed by the emulsion polymerization of a monomer mixture comprising a carboxyl-containing monomer, a hydroxyl-containing monomer, and butadiene, wherein the resin is substantially devoid of materials that release formaldehyde when cured.

2. The resin of claim 1, wherein the resin is a film-forming resin.

3. The resin of claim 1, wherein the resin is formed from a monomer mixture that is substantially devoid of (meth)acrylate or (meth)acrylamide resins.

4. The resin of claim 1, wherein the glass transition temperature of the polymer increases by at least 5° C. when the polymer is cured.

5. The resin of claim 1, wherein the monomer mixture further comprises styrene.

6. The resin of claim 1, wherein the monomer mixture further comprises a polymerizable esterification catalyst.

7. The resin of claim 1, in the form of a latex dispersion.

8. The resin of claim 1, in dried form.

9. The resin of claim 1, wherein the polymer has a glass transition temperature in the range of between about −40° C. and 150° C. before curing.

10. A roofing shingle comprising a fibrous mat impregnated with the thermosetting resin of claim 1.

11. The roofing shingle of claim 10, wherein the shingle is substantially devoid of urea/formaldehyde resins.

12. Fibrous insulation comprising fibers impregnated with the thermosetting resin of claim 1.

13. Thermosetting paper comprising wood particles bound together using the thermosetting resin of claim 1.

14. Composite materials comprising fiber tows, and/or fabrics produced from carbon or glass fibers, wherein the fiber tows and/or fabrics are impregnated with the thermosetting resin of claim 1.

15. Articles of manufacture produced by melting the dried powder of claim 8 at a temperature at which crosslinking of the carboxylic acid and hydroxyl groups does not occur to a significant extent, forming the melted powder into a desired shape, and then heating the resulting shaped object to a temperature at which crosslinking of the carboxylic acid and hydroxyl groups occurs.

16. The fibrous insulation of claim 12, wherein the fiber is glass.

17. The resin of claim 1, wherein the polymer glass transition temperature changes by at least 5° C. after curing.

18. Composite materials comprising wood particles, natural fibers, or other plant materials, wherein the wood particles, natural fibers, or other plant materials are bound together with the thermosetting resin of claim 1.

19. Articles of manufacture comprising minerals or mineral wool, wherein the minerals or mineral wool are bound together with the thermosetting resin of claim 1.

20. Composite materials comprising synthetic particles or fibers, wherein the synthetic particles or fibers are bound together with the thermosetting resin of claim 1.
